(19) United States
(12) Patent Application Publication
(10) Pub. No.: US 2024/0361461 A1
(43) Pub. Date: Oct. 31, 2024

(54) LIDAR SYSTEM AND METHOD FOR ENVIRONMENT MAPPING AND/OR LIDAR DATA ANALYSIS

(71) Applicant: Red Leader Technologies, Inc., Mountain View, CA (US)

(72) Inventors: Christopher Baca, Palo Alto, CA (US); Jacob Hillard, Palo Alto, CA (US)

(73) Assignee: Red Leader Technologies, Inc., Mountain View, CA (US)

(21) Appl. No.: 18/645,725

(22) Filed: Apr. 25, 2024

Related U.S. Application Data
(60) Provisional application No. 63/461,748, filed on Apr. 25, 2023.
(60) Provisional application No. 63/504,380, filed on May 25, 2023.

(51) Int. Cl. G01S 17/89

(52) U.S. Cl. CPC G01S 17/89

(57) ABSTRACT

A lidar system, preferably including one or more optical emitters, optical detectors, beam directors, and/or processing modules. A method for environment mapping and/or lidar data analysis, preferably including generating a spatial representation and processing the spatial representation. The method can optionally include sampling lidar data, generating temporal representations, and/or detecting object locations. The lidar system is preferably operable and/or configured to perform the method for environment mapping and/or lidar data analysis, but can additionally or alternatively have any other suitable functionality and/or be configured in any other suitable manner. The method for environment mapping and/or lidar data analysis is preferably performed using the lidar system, but can additionally or alternatively be performed using any other suitable system.

### CROSS-REFERENCE TO RELATED APPLICATIONS

This application claims the benefit of U.S. Provisional Application Ser. No. 63/461,748, filed on 25-Apr.-2023, and of U.S. Provisional Application Ser. No. 63/504,380, filed on 25-May-2023, each of which is incorporated in its entirety by this reference.

### TECHNICAL FIELD

This invention relates generally to the lidar field, and more specifically to a new and useful lidar system and method for environment mapping and/or lidar data analysis.

### BRIEF DESCRIPTION OF THE FIGURES

FIG. 1 is a schematic representation of an embodiment of a method for lidar data analysis.

FIG. 2A is a schematic representation of an embodiment of the lidar system.

FIG. 2B is a schematic representation of the embodiment of the lidar system in use.

FIG. 3 is a flowchart representation of an example of a first portion of the method.

FIG. 4 is a schematic representation of an example of rays emanating from a lidar system.

FIGS. 5A-5B are flowchart representations of a first and second example, respectively, of a second portion of the method.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

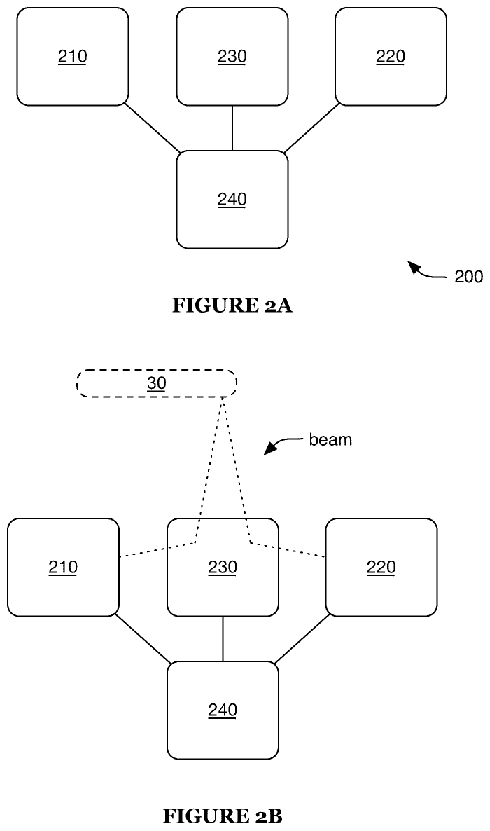

A lidar system 200 preferably includes one or more: optical emitters 210; optical detectors 220; beam directors 230; and/or processing modules 240 (e.g., as shown in FIGS. 2A-2B). The LIDAR system can optionally include one or more elements such as described in U.S. patent application Ser. No. 17/858,891, filed 6-Jul.-2022 and titled “LIDAR SYSTEM AND METHOD OF OPERATION”, U.S. patent application Ser. No. 17/946,844, filed 16-Sep.-2022 and titled “LIDAR SYSTEM AND METHOD OF OPERATION”, and/or U.S. patent application Ser. No. 17/738,959, filed 6-May-2022 and titled “LIDAR SYSTEM AND METHOD OF OPERATION”, each of which is incorporated herein in its entirety by this reference (e.g., includes the entire ‘lidar system 200’ described therein).

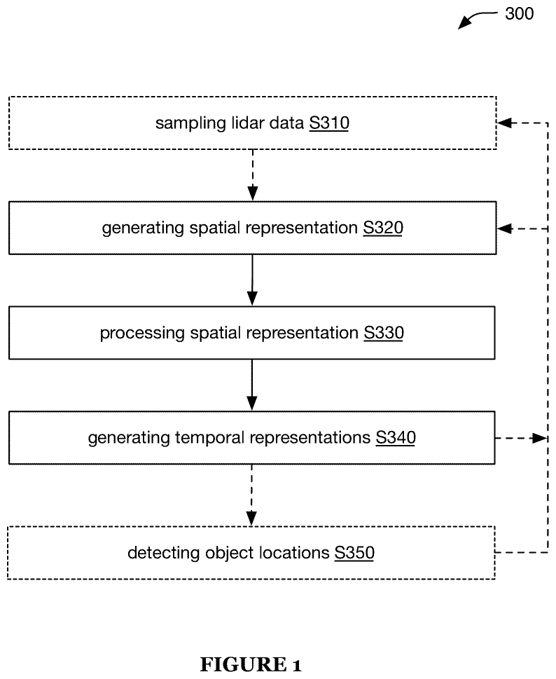

A method 300 for environment mapping and/or lidar data analysis preferably includes generating a spatial representation S320 and processing the spatial representation S330. The method can optionally include sampling lidar data S310, generating temporal representations S340, and/or detecting object locations S350. An embodiment of the method 300 is depicted in FIG. 1.

The lidar system 200 is preferably operable and/or configured to perform the method 300 described herein, but can additionally or alternatively have any other suitable functionality and/or be configured in any other suitable manner. The method 300 is preferably performed using the lidar system 200, but can additionally or alternatively be performed using any other suitable system.

### 2. Technical Advantages

Variants of the technology can confer several benefits over conventional systems and/or methods.

First, variants of the technology can benefit from colocalization of (some or all) data processing close to the point of lidar data sampling. The sampled lidar data would require tremendous bandwidth (e.g., tens of Gb/s) to transmit in its entirety (e.g., in a raw (or substantially raw form and/or raw histogram (or substantially raw histogram) form, such as ADC data and/or time to digital data of photon counts). Accordingly, typical systems will reduce the sampled lidar data from sets of signals collected over time (e.g., over the “short time” representing a lidar probe's transit time in the environment) down to a selected return peak (or any other suitable distinguished point or set of points) (and/or any other suitable representation of discrete returns and/or potential returns, rather than more complete representations of temporal signals) prior to transmission, which may subsequently be converted into a point cloud (and/or other suitable representation of the data), preferably after suitable application of one or more 3-dimensional projections; after such a reduction, some processing techniques (e.g., some of the processing techniques described herein, such as regarding S330) are no longer possible. In contrast, variants of the technology can preserve temporal representations and perform such processing, which can greatly increase the accuracy, resolution, and/or other performance metrics associated with the information that can subsequently be derived from this processed lidar data. In some such examples, this processing can exploit the strong spatial correlations (e.g., in angle space) that lidar data is expected to exhibit (along with the minimal temporal correlations expected in lidar data “short time”). For example, this processing (e.g., localized processing) can perform and/or facilitate detection and/or enhancement of geometric features (e.g., edges, surfaces, etc.) in the lidar data, thereby enabling the technology to reveal far superior information indicative of such features (e.g., as compared with typical technologies such as described above). A person of skill in the art will note that such enhancements may be possible even without colocalization of lidar data sampling and processing (e.g., but may require significant bandwidth to transfer the lidar data to be processed).

Second, variants of the technology can additionally or alternatively increase processing efficiency, such as by reducing computing resource requirements for applying some filters and/or pre-processing to lidar data. For example, one or more linear filters (e.g., LTI filters) may be applied to lidar data prior to demultiplexing, thereby enabling a reduction in processing requirements for such an application (e.g., reduced by a factor substantially equal to the number of signals multiplexed into each vector of temporal data).

Third, variants of the technology can additionally or alternatively facilitate efficient and/or performant application of one or more kernels (e.g., filtering/processing kernels). For example, by organizing the lidar data into a spatial representation (e.g., and subsequently taking slices, such as slices along the time dimension, from this spatial representation), some such variants can facilitate application of such kernel(s) by one or more efficient computing systems, such as GPU-and/or systolic array-based computing systems.

However, the technology can additionally or alternatively confer any other suitable benefits.

### 3. Lidar System

The optical emitter(s) 210 (e.g., lasers) preferably function to (e.g., are operable to) emit one or more optical signals. The optical signals are preferably beam-like (e.g., laser beams), but can additionally or alternatively have any other suitable optical characteristics. The optical emitters can include pulsed emitters (e.g., operable and/or configured to emit pulses of radiation), continuous wave emitters (e.g., operable and/or configured to emit substantially continuous wave radiation, such as amplitude-modulated and/or frequency-modulated continuous wave radiation), and/or any other suitable emitters.

In one specific example, one or more of the emitters (e.g., lasers) emit light with a wavelength of substantially 900 nm (e.g., 890-910 nm, 875-925 nm, etc.). In a second specific example, one or more of the emitters (e.g., lasers) emit light with a wavelength of substantially 1550 nm (e.g., 1540-1560 nm, 1525-1575 nm, etc.). In a third specific example, one or more of the emitters (e.g., lasers) emit light with a wavelength of substantially 835 nm (e.g., 820-850 nm, 800-870 nm, etc.). The light intensity emitted by the emitter (e.g., laser) is preferably lower than or equal to the limit prescribed by regulatory standards (e.g., the laser can be compliant with IEC-60825, IEC-62471, etc.), but can alternatively be higher. The signal power can be within regulatory limits (e.g., less than a threshold power, such as 5 W 2 W, 1 W, 500 mW, 200 mW, 100 mW, 50 mW, 20 mW, 10 mW, 5 mW, 2 mW, 1 mW, 0.5 mW, 0.2 mW, or 0.1 mW, etc.), preferably less than 1 mW, but can alternatively be higher or lower. However, the emitters can additionally or alternatively include any other suitable lasers and/or other emitters.

Some or all of the optical emitters 210 can optionally include one or more modulators. The modulators can be operable to modulate one or more aspects (e.g., phase, intensity, wavelength, duty cycle, pulse duration, pulse repetition rate, etc.) of the light emitted by the emitter. However, the system 200 can additionally or alternatively include any other suitable modulators, and/or can include no such modulators.

The optical detector(s) 220 preferably function to (e.g., are operable to) generate an electrical signal (e.g., current, voltage, etc.) in response to optical detection (e.g., representative of the detected optical signal), but can additionally or alternatively generate any other suitable signal (e.g., representative of the detected optical signal) in response to optical signal detection. For example, the optical detectors can include one or more optoelectronic transducers, such as photodiodes (e.g., avalanche photodiodes). The optical detector(s) 220 can optionally include (and/or be supplemented by) one or more demodulators (e.g., digital demodulators, such as computationally-implemented demodulators; analog demodulator circuits; etc.), such as demodulators complementary to the modulators (e.g., configured to convert the encoded signal back into the original sequence). Additionally or alternatively, the optical detector(s) can optionally include signal processing electronics, such as one or more analog-to-digital converters (ADCs). However, the system 200 can additionally or alternatively include any other suitable optical detectors.

The beam director(s) 230 preferably functions to direct the optical signal(s) between aspects of the system 200 and the external environment. For example, a beam director 230 can direct an emitted optical signal (e.g., beam) from an optical emitter 210 to an external location 30 (within the external environment), wherein the optical signal reflects off the external location 30 (and/or other external locations). The optical signal is preferably reflected back to the beam director 230, which directs the reflected signal to an optical detector 220. However, the optical signal can additionally or alternatively be reflected to another beam director 230 (e.g., which directs the signal to the optical detector 220), to the optical detector 220, and/or to any other suitable element(s) of the system 200. Each beam director 230 can direct one or more emitted signal and one or more reflected signals, and can direct the signals between one or more optical emitters 210, external locations 30, and/or optical detectors 220 (e.g., as shown in FIG. 2B). In one example, the beam director 230 includes one or more mirrors, preferably moving and/or moveable mirrors such as rotating mirrors (e.g., continuously rotating) and/or MEMS-based mirrors (e.g., configured to move in response to control inputs), which can direct the optical signal to many external locations 30 over time (e.g., scanning the beam over the locations as the mirror rotates). However, the system 200 can additionally or alternatively include any other suitable beam directors, or include no beam director.

The processing module(s) 240 preferably function to: control other elements of the system 200, such as the optical emitters 210 (e.g., controlling optical emission and/or modulation) and/or beam directors 230 (e.g., controlling the direction of the beam); receive data from other elements of the system 200, such as the optical detectors 220 (e.g., receiving signals associated with light detection); and/or process (e.g., interpret) the received data, such as to determine information about the external environment (e.g., positions of the external locations 30). The processing module 240 is preferably communicatively (e.g. electronically) coupled to the optical emitters 210, optical detectors 220, beam directors 230, and/or any other suitable elements of the system. The processing module 240 preferably includes one or more processors (e.g., CPUs, GPUs, systolic arrays, microprocessors, FPGAs, ASICs, etc.) and/or storage units (e.g., Flash, RAM, etc.), but can additionally or alternatively include any other suitable elements. In some variations, the processing module 240 (and/or a supplementary processing module) can be physically separated from the other elements of the lidar system (e.g., wherein the lidar system includes a communication module, such as a wireless communication module, configured to communicate with the processing module). For example, the processing module 240 can be a remote computing system (e.g., Internet-connected server), and the lidar system can communicate with the remote computing system (e.g., wherein some or all computations of the method are performed by the remote computing system). However, the system 200 can additionally or alternatively include any other suitable processing modules.

In alternate embodiments, the system 200 may include one or more processing modules, but may not include any optical emitters, optical detectors, beam directors, and/or other elements associated with sampling lidar data. For example, in such embodiments, the system 200 may function only to analyze (e.g., rather than sample) lidar data (and/or other data, such as other spatial data indicative of object positions within an environment).

### 4. Method

### 4.1 Sampling Lidar Data.

The method can optionally include sampling lidar data S310. For example, S310 can include transmitting one or more optical probe signals (e.g., laser outputs, such as pulses, sporadic emissions, and/or continuous emissions, etc.), receiving reflected optical signals (e.g., in response to reflection of one or more of the optical probe signal(s) from one or more objects in the environment surrounding the lidar system), sampling the reflected optical signals (e.g., at one or more detectors, such as detectors including optoelectronic transducers and/or signal processing electronics), and/or processing the sampled optical signals (e.g., performing filtering, decoding, deconvolution, etc.).

In some examples, S310 includes one or more elements such as described in U.S. patent application Ser. No. 17/858,891, filed 6-Jul.-2022 and titled “LIDAR SYSTEM AND METHOD OF OPERATION”, U.S. patent application Ser. No. 17/946,844, filed 16-Sep.-2022 and titled “LIDAR SYSTEM AND METHOD OF OPERATION”, and/or U.S. patent application Ser. No. 17/738,959, filed 6-May-2022 and titled “LIDAR SYSTEM AND METHOD OF OPERATION”, each of which is incorporated herein in its entirety by this reference (e.g., such as described therein regarding the ‘method 100’ and/or any other suitable element(s) thereof).

In a first example, S310 can include sampling and/or receiving multiplexed (e.g., code-division multiplexed) and/or encoded lidar data (and can optionally include demultiplexing and/or decoding this lidar data), such as described by way of example in U.S. patent application Ser. No. 18/144,070, filed 5-May-2023 and titled “LIDAR SYSTEM AND METHOD OF OPERATION”, which is herein incorporated in its entirety by this reference. For example, S310 can include transmitting one or more encoded optical probe signals (e.g., continuous-wave laser output modulated based on a periodic encoding pattern), receiving reflections of one or more of the encoded optical probe signals, sampling the received signals, and optionally decoding the sampled signals (e.g., by deconvolving from the known periodic encoding pattern(s)), wherein this decoding can function to demultiplex the different probe reflections multiplexed in the received signal. However, in some embodiments, decoding and/or demultiplexing can be deferred until after generating the spatial representation in S320 (e.g., wherein processing and/or memory requirements, such as those associated with generating the spatial representation, decoding and/or demultiplexing, and/or performing the method as a whole, may be reduced by deferring decoding and/or demultiplexing in this manner).

In a first variation of the first example, the encodings of the multiplexed signals can be selected such that they generate one or more known “aggressor” returns in the signals associated with other encodings (e.g., wherein the encodings have known cross-correlations with each other. These known aggressor returns will be associated with a known temporal offset from the true returns in the signals; accordingly, a spatial filter can be designed to remove or reduce these known aggressor returns (e.g., as described below in more detail regarding S330).

In a second variation of the first example (additional or alternative to the first variation), decoding of the signals may be performed in a manner that varies with the vectors' positions in angle space. For example, the decoding may be performed using a decoding matrix incorporating some randomness (e.g., via high-dispersion sequences, Sobol' sequences, etc.), and/or incorporating aspects configured to compensate for physical phenomena (e.g., laser rise and/or fall time, thermal noise, etc.). However, the decoding can additionally or alternatively be performed in any other suitable manner.

In a second example, S310 includes transmitting one or more pulsed optical probe signals (e.g., a single pulse or isolated set of pulses for each probe signal), receiving reflections of one or more of the optical probe signals, and sampling the received signals (e.g., transducing the optical signal into an analog electrical signal, and optionally converting the analog electrical signal to a digital representation).

In a third example, S310 includes transmitting one or more amplitude-modulated continuous wave (AMCW) optical probe signals, receiving reflections of one or more of the optical probe signals, and sampling the received signals (e.g., transducing the optical signal into an analog electrical signal, and optionally converting the analog electrical signal to a digital representation).

In a fourth example, S310 includes transmitting one or more frequency-modulated continuous wave (FMCW) optical probe signals, receiving reflections of one or more of the optical probe signals, and sampling the received signals (e.g., transducing the optical signal into an analog electrical signal, and optionally converting the analog electrical signal to a digital representation).

However, S310 can additionally or alternatively include sampling lidar data in any other suitable manner. Further, the method can additionally or alternatively include receiving lidar data in any other suitable manner, such as receiving lidar data from a separate lidar system, from a database, and/or from any other suitable source (e.g., in embodiments in which a system does not include elements operable to sample lidar data from the system's surroundings, the system may be configured only to analyze lidar data, rather than to both sample and analyze the data).

### 4.2 Generating a Spatial Representation.

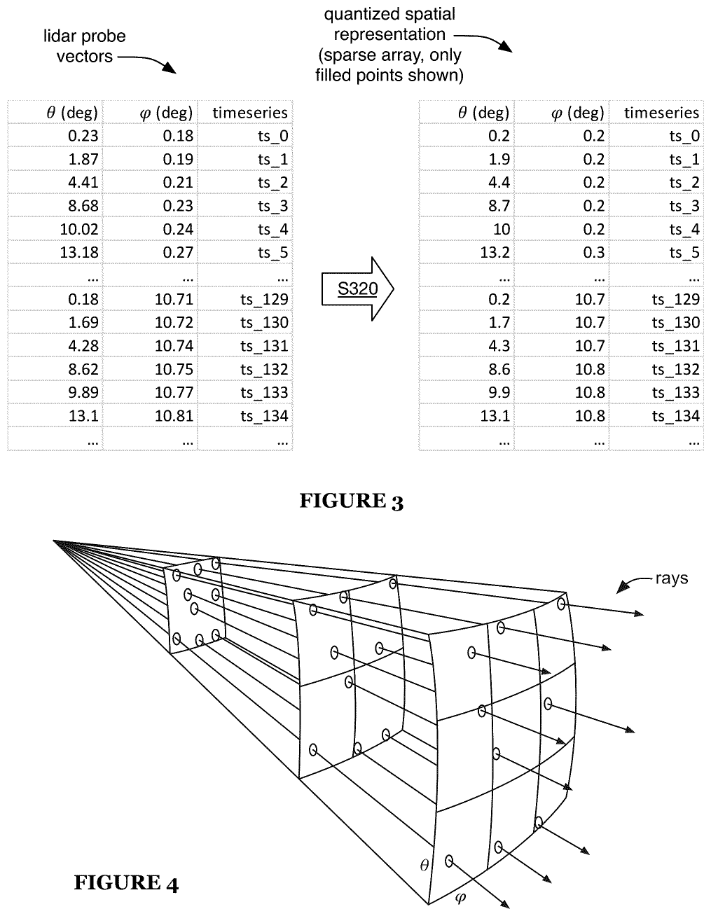

Generating a spatial representation S320 preferably functions to map temporal exposure data (e.g., sampled in S310) onto one or more spatial representations (e.g., quantized spatial representations), such as shown by way of example in FIG. 3.

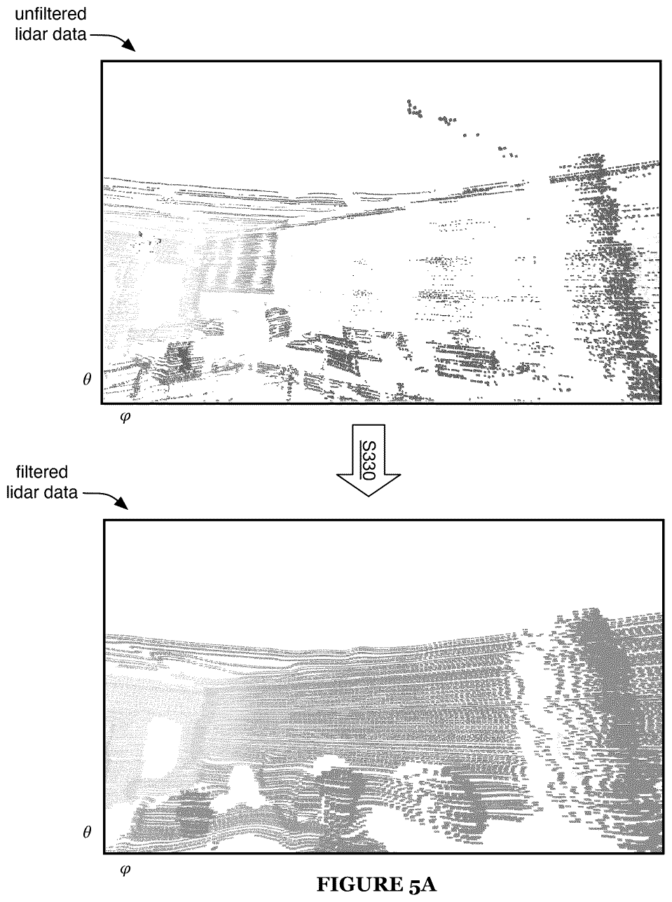

The spatial representation is preferably generated using temporal data for each of a set of lidar probe vectors (e.g., sampled in S310). For example, each lidar probe vector of the set can represent a ray directed outward from the lidar system (e.g., as shown in FIG. 4), such as an optical probe signal directed outward substantially along the ray, and/or reflected back to the system substantially along the ray (e.g., ignoring any deviations from the ray that the probe signal may take outside of the system, such as deviations due to specular reflection of the probe signal part way along the length of the ray, thereby redirecting the probe signal from the ray onto a different trajectory or redirecting the probe signal from a different trajectory onto the ray). Each lidar probe vector of the set preferably is (or is representative of) a timeseries of signal amplitude (e.g., received signal amplitude, filtered signal amplitude, such as signal amplitude deconvolved from a probe signal encoding, etc.). This timeseries preferably represents “short time” data (e.g., data corresponding to the duration of a single lidar probe), which is typically data indicative of range information (e.g., wherein the “short time” represents the round-trip time (RTT) for light propagation from the system to the object in the environment off which it reflects and back to the system). A person of skill in the art will recognize that the term “short time” may be used here in contrast with “long time”, wherein “long time” typically corresponds to multiple lidar probes directed in the same (or substantially the same) angular direction, wherein data changing over “long time” is typically indicative of changes over time in the pose of the system and/or of objects in the environment surrounding the system.

S320 preferably includes mapping each lidar probe vector of the set onto a grid in angle space. Here, each lidar probe vector of the set may be associated with arbitrary angular values (e.g., values of angular directions, such as azimuth and/or elevation), whereas the grid preferably defines a regular array in this angle space (e.g., including regularly spaced values in the angular directions, such as in the azimuth and elevation directions). Accordingly, in some examples, this mapping may be referred to as quantizing the angular values (e.g., the azimuth and elevation values). This mapping (e.g., angular quantization) may result in a sparsely-populated grid (e.g., including many gaps between grid locations populated with timeseries data). In examples in which the grid spacing is a power of the base system in which the grid positions are represented (e.g., power of 10 for grid positions represented in decimal, power of 2 for grid positions represented in binary, etc.), this mapping process can include (e.g., consist of or consist essentially of) rounding the angle values (e.g., azimuth and elevation values) to the resolution of the grid.

The original timeseries of each input lidar probe vector of the set is preferably preserved without change through this mapping process (e.g., only the angular values defining the ray direction are changed in the mapping). However, the mapping process can alternatively include resampling and/or otherwise altering the timeseries values (e.g., via interpolation between nearby timeseries). In some examples (e.g., in which a low-resolution grid is employed), some grid locations may have multiple probe vectors mapped to them (e.g., in which case, the temporal data of the multiple probe vectors may be averaged and/or combined in any other suitable manner, and the combined timeseries may be associated with the corresponding grid location).

This mapping preferably results in a spatial representation that may be sparse in the angular dimensions (e.g., along the azimuth and/or elevation axes), but dense (e.g., continuous or substantially continuous, such as quantized by the temporal resolution of the set of lidar probe vectors) in the time dimension. Additionally or alternatively, S320 can include generating a set of spatial representations such as wherein each spatial representation of the set is a slice along the time dimension (and/or along any other suitable direction).

In some embodiments, S320 can include applying one or more filters (e.g., linear time-invariant (LTI) filters), such as spectral whitening and/or normalization, to the spatial representation (and/or to any suitable subset thereof). In examples in which the lidar data is decoded and/or demultiplexed, such filters are preferably applied prior to decoding and/or demultiplexing (e.g., wherein the associated computational load of applying such filters may be reduced by performing it in this order, such as reduced substantially by a factor equal to the degree of multiplexing present in the lidar data sampled and/or received in S310). However, such filters can additionally or alternatively be applied with any other suitable timing (e.g., within S320, prior to performing S320 such as in response to sampling and/or receiving the lidar data in S310, after performing S320 such as along with applying other filters in S330, etc.).

In some embodiments (e.g., in which the lidar data sampled and/or received in S310 is multiplexed and/or encoded), S320 can include decoding and/or demultiplexing the spatial representation (e.g., wherein such decoding and/or demultiplexing has been deferred to S320, such as described above regarding S310).

However, S320 can additionally or alternatively include generating any other suitable spatial representations in any suitable manner.

### 4.3 Processing the Spatial Representations.

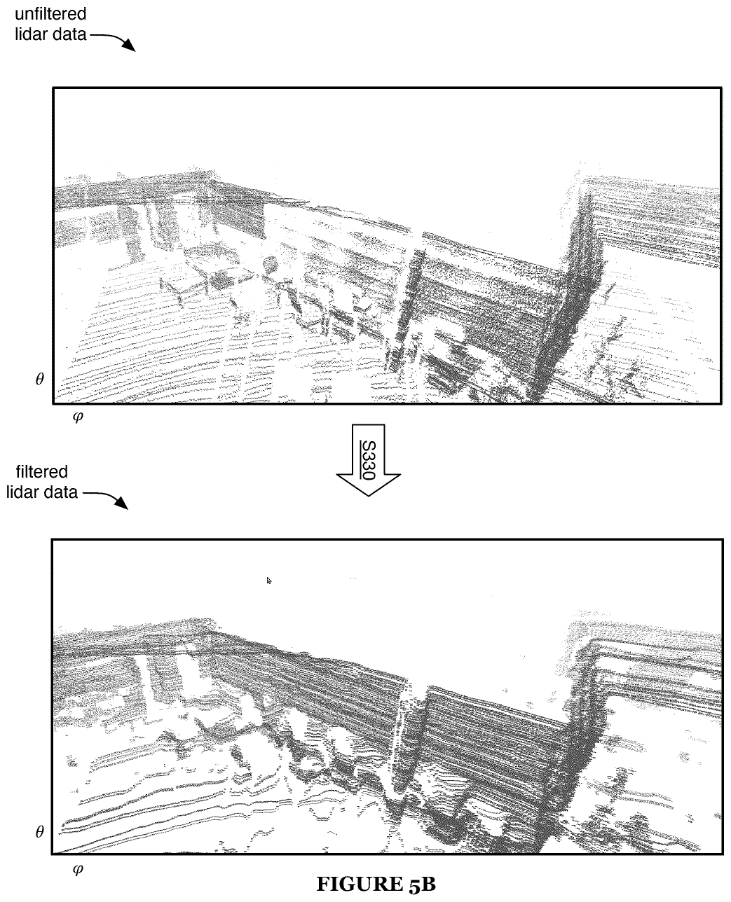

Processing the spatial representations S330 preferably functions to perform spatial filtering of the lidar data, such as shown by way of examples in FIGS. 5A-5B, in which different colors represent depth information (e.g., wherein the color at each angular position is selected based on the time dimension value corresponding to the maximum amplitude of the time series for that angular position).

S330 preferably includes generating a plurality of slices based on the one or more spatial representations generated in S320. These slices can be two-dimensional slices, thin three-dimensional slices (e.g., including only a few values along one thin dimension, such as along the time axis), and/or have any other suitable shape and/or dimensionality. The slices can be sliced along the time axis (e.g., wherein, for each data slice, or for any suitable subset of data slices, the data slice represents a respective constant value along the time dimension), along a surface normal (e.g., surface detected in the spatial representation and/or in previous time points detected by the lidar system; surface detected based on auxiliary information such as information received via auxiliary sensors, via sensor fusion such as fusion of auxiliary sensor data with lidar data, via simultaneous localization and mapping, etc.), and/or sliced along any other suitable direction. In some examples, S330 can include generating multiple sets of slices, wherein each such set is sliced along a different direction.

S330 preferably includes processing each of these slices (and/or any suitable subset thereof). For each such slice, S330 preferably includes applying one or more processing filters (e.g., filters associated with computer vision techniques), such as geometric filters and/or filters based on significance testing. In examples, the processing filters can include Gaussian filters (e.g., optionally including second-level Gaussian filters), bilateral filters, nearest neighbors filters, edge detection filters, Laplacian super-resolution filters, neural network-based filtering, computational imaging techniques, geometric filtering techniques, point cloud filtering techniques, and/or any other suitable filters. S330 can include performing the same processing for each slice and/or performing different processing for any suitable slices of the plurality. Additionally or alternatively, S330 can include performing 3D processing (e.g., on thicker slices, on the entire spatial representation, etc.).

In some embodiments (e.g., in which multiplexed lidar signals are associated with known aggressor characteristics between each other, such as described above in more detail regarding S310), S330 can include applying one or more filters operable to remove and/or reduce aggressor signals arising from “cross-talk” between different lidar probes (e.g., cross-correlations between multiplexed lidar signals, such as known cross-correlations). For example, applying such a filter can include: detecting a set of real returns exhibiting spatial correlations between nearby vectors of the spatial representation (e.g., associated with neighboring and/or otherwise nearby lidar probe vectors in the environment), such as real returns at the same or similar temporal values within the nearby vectors; and for each vector exhibiting such a real return (or for any suitable subset thereof), filtering (e.g., removing or reducing in intensity) the portion of the vector displaced from its respective real return by the temporal offset(s) associated with the known aggressor returns for that vector. In a first specific example, a first and second demultiplexed vector both originated from a single multiplexed vector, wherein the first vector is known to exhibit aggressor returns at temporal values of τ₁ greater than its real returns, and the second vector is known to exhibit aggressor returns at temporal values of τ₂ greater than its real returns. In this first specific example, a real return is present in both the first and second vector at a temporal value of t; in response to the presence of these real returns, the filter can remove (or alternatively, reduce or otherwise filter) signals present at (and/or around) t+τ₁ in the first vector and signals present at (and/or around) t+τ₂ in the second vector. In a second specific example, an environmental feature exhibiting significant spatial continuity (e.g., and thus expected to be real, rather than spurious) is detected based on returns in numerous vectors; in response to this detection, a geometric filter could function to filter potential aggressor returns in any or all such vectors exhibiting a return consistent with the environmental feature (e.g., based on the respective temporal offset(s) associated with each such vector). However, such “geometric” filtering can additionally or alternatively be performed in any other suitable manner.

S330 preferably includes reassembling the processed slices into a whole spatial representation (e.g., re-stacking the processed slices along the slice direction, such as along the time axis or the surface normal). The result of this reassembly is preferably a processed spatial representation. This processed spatial representation preferably has the same shape and/or dimensionality as the input spatial representation. However, the processed spatial representation may have different sparsity than the input representation (e.g., wherein the processing applied in S330 may include interpolation and/or other densification of the data).

However, S330 can additionally or alternatively include processing the spatial representations in any other suitable manner.

### 4.4 Generating Temporal Representations.

The method can optionally include generating temporal representations S340, which can function to cast the one or more processed spatial representations back into processed analogs of lidar probe vectors (“processed vectors”). Herein, each such processed vector is preferably a temporal representation, as it includes a timeseries (e.g., in “short time”), such as a timeseries representative of signal intensity over time.

S340 preferably includes extracting a processed vector along the direction of each input lidar probe vector. Here, each processed vector extracted is analogous to the corresponding input lidar probe vector, but includes the processing applied in S330. Each processed vector can be associated with the original angle values of the corresponding input vector, the quantized angle values of the spatial representation, and/or any other suitable angle values.

S340 can additionally or alternatively include extracting processed vectors along any other suitable directions. For example, S340 can additionally or alternatively include extracting processed vectors along all directions present within the processed spatial representation, or any suitable subset thereof (e.g., all directions on a coarser grid in angular space).

In variants in which the input lidar probe vectors are encoded (e.g., wherein the lidar data results from encoded lidar probe signals), S340 can optionally include decoding and/or demultiplexing (some or all of) the processed vectors. In one variant, in which the input lidar probe vectors may include signals resulting from multiple different encoded lidar probe signals (e.g., reflection of differently-encoded probe signals off of different objects and/or different positions on an object), decoding the processed vectors can include performing a separate decoding for each such encoding (e.g., independently deconvolving the encoded signal from each of the encodings). For example, if four different periodic encodings are employed in lidar probe signal transmission, decoding a single encoded vector preferably results in four different processed vectors (one for each of the four different encodings). However, such decoding and/or demultiplexing can additionally or alternatively be performed at an earlier (or later) point in the method, such as before applying any filters to the spatial representation (e.g., excluding linear filters such as LTI filters, which may be applied prior to decoding), such as described above in more detail.

However, S340 can additionally or alternatively include generating any other suitable temporal representations.

### 4.5 Detecting Object Locations.

The method can optionally include detecting object locations S350, which can function to generate a point cloud from the temporal representations. S350 can include renormalizing temporal representations, applying a point detection algorithm, and associating detected points with locations.

Renormalizing the temporal representations can function to facilitate detection of 0-1 peaks in each processed vector, as each vector typically includes 0 or 1 true peaks (e.g., corresponding to reflection off an object along the corresponding ray), and only occasionally includes a plurality of true peaks (e.g., a small plurality, such as 2-3). Accordingly, signal processing that facilitates detection of a small number of peaks can be beneficial. Renormalizing the temporal representations preferably includes normalizing each processed vector (e.g., generated in S340) independently. For example, renormalizing a processed vector can include determining a metric of statistical dispersion (e.g., standard deviation, average absolute deviation, median absolute deviation, maximum absolute deviation, variance, interquartile range, etc.; and/or a Winsorized version of any suitable metric, such as any suitable metric of statistical dispersion listed herein, which can include, in examples, a 95%, 90%, 85%, 80%, or 75% Winsorized deviation such as average or median absolute deviation, etc.) of the timeseries of that processed vector and normalizing the timeseries based on the value of that metric of statistical dispersion (e.g., dividing each value of the timeseries by the standard deviation of the timeseries). Additionally or alternatively, a normalization value can be determined based only on a subset of the processed vector to be normalized; for example, a locality-specific metric (e.g., metric of statistical dispersion, such as standard deviation, etc.) of a local temporal window (sliding window, such as a window centered about each temporal position within the vector to be normalized) within the processed vector can be determined (e.g., wherein the result is a normalization vector that varies along the temporal axis, preferably wherein normalizing the processed vector includes dividing the processed vector by the normalization vector). However, the temporal representations can additionally or alternatively be renormalized in any other suitable manner.

Applying a point detection algorithm preferably functions to detect the true peaks present in the processed vectors. The point detection algorithm is preferably applied to the renormalized temporal representation. In one example, the point detection algorithm is a constant false alarm rate (CFAR) algorithm. However, any other suitable point detection algorithms may be employed.

Associating each detected point with a location preferably includes determining a direction and range for each detected point. The direction is preferably equivalent to the direction of the processed vector in which the point is detected. The range is preferably determined based on the round-trip time for light propagation to the point (e.g., calculated as D=c/2t, wherein D is the range, t is the round-trip time, and c is the speed of light).

However, S350 can additionally or alternatively include detecting object locations in any other suitable manner. Further, the method 300 can additionally or alternatively include any other suitable elements performed in any suitable manner.

Although omitted for conciseness, the preferred embodiments include every combination and permutation of the various system components and the various method processes. Furthermore, various processes of the preferred method can be embodied and/or implemented at least in part as a machine configured to receive a computer-readable medium storing computer-readable instructions. The instructions are preferably executed by computer-executable components preferably integrated with the system. The computer-readable medium can be stored on any suitable computer readable media such as RAMs, ROMs, flash memory, EEPROMs, optical devices (CD or DVD), hard drives, floppy drives, or any suitable device. The computer-executable component is preferably a general or application specific processing subsystem, but any suitable dedicated hardware device or hardware/firmware combination device can additionally or alternatively execute the instructions.

The FIGURES illustrate the architecture, functionality and operation of possible implementations of systems, methods and computer program products according to preferred embodiments, example configurations, and variations thereof. In this regard, each block in the flowchart or block diagrams may represent a module, segment, step, or portion of code, which comprises one or more executable instructions for implementing the specified logical function(s). It should also be noted that, in some alternative implementations, the functions noted in the block can occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As a person skilled in the art will recognize from the previous detailed description and from the figures and claims, modifications and changes can be made to the preferred embodiments of the invention without departing from the scope of this invention defined in the following claims.

We claim:

1. A method for environment mapping, comprising:
receiving lidar data comprising a plurality of temporal signals, each temporal signal of the plurality associated with a different spatial heading;
generating a spatial representation associated with an array in angle space, comprising mapping each temporal signal of the plurality onto the grid, wherein the spatial representation is associated with a time dimension and at least one spatial angle dimension;
selecting a set of data slices from the spatial representation;
for each data slice of the set, generating a respective filtered slice, comprising applying a spatial filter to the data slice; and
based on the filtered slices, determining a plurality of processed vectors, each processed vector of the plurality associated with a different spatial heading.

2. The method of claim 1, wherein each temporal signal of the plurality is representative of received signal intensity as a function of optical probe signal propagation time.

3. The method of claim 1, further comprising, before generating the spatial representation, sampling the lidar data, comprising:
transmitting a plurality of optical probe signals into an environment, each optical probe signal of the plurality transmitted along a different spatial heading;
receiving reflections of optical probe signals of the plurality; and
determining the plurality of temporal signals based on the reflections.

4. The method of claim 3, wherein determining the plurality of temporal signals comprises, for each optical probe signal of the plurality: sampling a respective temporal signal of the plurality of temporal signals, the respective temporal signal representative of received signal intensity as a function of optical probe signal propagation time, the respective temporal signal associated with the respective spatial heading along which the optical probe signal was transmitted.

5. The method of claim 1, wherein:
the at least one spatial angle dimension comprises a first angle dimension and a second angle dimension, wherein the spatial representation is associated with the first angle dimension and the second angle dimension; and
each data slice of the set is a two-dimensional data slice.

6. The method of claim 5, wherein, for each data slice of the set, applying the spatial filter comprises applying a non-linear filter.

7. The method of claim 5, wherein, for each data slice of the set, applying the spatial filter comprises applying at least one filter selected from the group consisting of: a Gaussian filter, a bilateral filter, an edge detection filter, and a Laplacian super-resolution filter.

8. The method of claim 5, wherein, for each data slice of the set, the data slice represents a respective constant value along the time dimension.

9. The method of claim 5, further comprising determining a surface normal of a surface present in the environment; wherein a first data slice of the set is sliced substantially along the surface normal.

10. The method of claim 9, wherein determining the surface normal is performed based on the spatial representation.

11. The method of claim 9, wherein determining the surface normal comprises performing simultaneous localization and mapping.

12. The method of claim 9, further comprising receiving auxiliary information about the environment, the auxiliary information indicative of a position of the surface; wherein determining the surface normal is performed based on the auxiliary information.

13. The method of claim 1, further comprising, based on the filtered slices, generating a processed spatial representation associated with the time dimension and the at least one spatial angle dimension; wherein each processed vector of the plurality is selected from the processed spatial representation.

14. The method of claim 1, further comprising generating a point cloud, comprising detecting peaks in processed vectors of the plurality.

15. The method of claim 14, wherein generating the point cloud further comprises renormalizing each processed vector of the plurality, wherein, for each processed vector in which one or more peaks are detected, the processed vector is renormalized before detecting peaks.

16. The method of claim 15, wherein, for each processed vector of the plurality, the processed vector is renormalized based on a metric of statistical dispersion of the processed vector.

17. The method of claim 1, wherein the spatial representation comprises a sparse array, in the angle space, of temporal signals.

18. The method of claim 1, further comprising, for each temporal signal in the spatial representation, demultiplexing the temporal signal into a respective set of demultiplexed temporal signals.

19. The method of claim 18, further comprising, before demultiplexing the temporal signals, applying a linear time-invariant filter to the spatial representation.

20. The method of claim 18, wherein, for each set of demultiplexed temporal signals, each demultiplexed temporal signal of the set is associated with a different heading in the angle space.
